(19) United States
(12) Patent Application Publication
(10) Pub. No.: US 2015/0191036 A1
(43) Pub. Date: Jul. 9, 2015

(54) SUBSTRATE FOR SECURITY DOCUMENTS

(71) Applicant: De La Rue International Limited, Basingstoke, Hampshire (GB)

(72) Inventors: Rohan Ratnakumar, Basingstoke (GB); Paul Howland, Andover Hampshire (GB)

(21) Appl. No.: 14/404,235

(22) PCT Filed: Jun. 17, 2013
(86) PCT No.: PCT/GB2013/051282

§ 371 Date: Nov. 26, 2014

(30) Foreign Application Priority Data
May 29, 2012 (GB) 1209516.2

(51) Int. Cl. B42D 25/29; D21H 19/34

(52) U.S. Cl. CPC B42D 25/29; D21H 19/34

(57) ABSTRACT

Provided is a durable substrate for security documents such as banknotes, cheques, identification documents, etc. and a method of manufacturing such a substrate. A soil resistant paper substrate is made from a stock having a suspension of paper fibres. The paper substrate is treated with microfibrillated cellulose. The microfibrillated cellulose bridges pore spaces formed by and in between the paper fibres at least at a surface of the substrate to provide soil resistance. The microfibrillated cellulose may be added to the stock, and/or applied prior to printing and/or after printing.

The present invention provides a durable substrate for security documents such as banknotes, cheques, identification documents etc. and a method of manufacturing such a substrate. In particular, the present invention relates to durable substrates that are resistant to the build-up of soil on their surfaces, thereby reducing the rate at which documents are out-sorted by sorting machines or otherwise rejected for further use as information provided on the document becomes unreadable.

Security documents such as banknotes, identification documents and other such multi-use documents are subjected to regular handling and storage in places in which soil (e.g. oils and dirt) can accumulate and be transferred to the surface of the document. Soil can eventually build up to such an extent as to render security features or security information provided thereupon difficult to read by either human or machine scrutiny. At this point, the document must be taken out of circulation, destroyed and replaced, at a cost borne by the bearer or the bank note issuing authority.

Durable security documents are already known. Banknotes in some countries, such as Australia and Canada, are printed on polymeric substrates which have an enhanced lifespan over conventional paper-based substrates. Whilst these polymeric substrates offer improved physical durability, this comes with a number of disadvantages, such as increased initial manufacturing costs and the increased complexity in trying to incorporate certain types of security devices, which would be incorporated into paper-based substrates at the time of their manufacture, e.g. watermarks, embedded or windowed security elements etc. Additionally polymer substrates have a polymer tactility, which means that such banknotes no longer have the traditional feel and sound of a banknote.

Composite paper-polymer substrates are also known in the art, and laminar substrates having paper-polymer-paper or polymer-paper-polymer structures are commercially available. These go some way to addressing the security limitations of purely polymer-based substrates, but again at very high manufacturing costs. Furthermore they can suffer particularly in humid environments where differences in hygro-expansivity between the paper and polymeric layers result in inherent weaknesses in the laminar substrate that present opportunities to the counterfeiter.

Soil-resistant traditional paper security substrates are also commercially available, such as the Platinum®-coated paper made by De La Rue (UK), or the AST-coated paper from Crane & Co (USA). In these systems, synthetic polymer-based soil-resistant coatings are applied to the surface of the substrate to size and seal it against the ingress of oils and dirt encountered in circulation.

While all of these approaches go some way to solving the problem of providing durable security substrates, there still remains a need for documents with enhanced circulation lifetimes. In particular, there still remains a need for security substrates having improved soil resistance and physical integrity combined with reduced environmental impact including end-of-life biodegradability or facile re-pulping of production spoil.

As cellulose is one of the most commonly found natural polymers, much research has been carried out over the years into ways of processing cellulose fibres to improve their usefulness. This lead to research into microfibrillating cellulose. Microfibrillation is the process of opening up the fibre structure to increase the surface-to-volume ratio thereof. It also results in the shortening of the fibres, resulting in a fine particle size of the order of microns to tens of microns such that the microfibrils exhibit a gel-like characteristic in water with pseudo plastic and thixotropic properties. The manufacture of microfibrillated cellulose (MFC) first came about in the late 1970s. However the aforementioned properties make MFC a difficult material to handle so commercial uses of MFC have been slow to develop.

In the packaging industry, it has been found that MFC enhances the properties of a water vapour barrier of a dispersion coating made from colloidal particles of a polymer. This is described in WO-A-2011/056130. The addition of the MFC to the dispersion coating has been shown to improve the water holding capacity and reduces the brittleness of the coating.

WO-A-2011/078770 describes the use of MFC in a layered arrangement to provide a paper or paperboard substrate having barrier properties against liquids, vapour and gases. To provide this the paper or paperboard substrate has a first fibre based layer, a second layer comprising MFC and a third layer comprising a polymer. The MFC layer is provided to increase the density of the fibre layer and to smooth the surface thereof, which in turn increases the smoothness and the adherability of the polymer layer which provides the known barrier to liquids/vapour. It has been found that the combination of the MFC and the polymer layers provides good oxygen barrier properties which are not provided by the use of the polymer coating by itself.

The prior art is concerned with using MFC as part of a polymer based barrier coating. Polymer based barrier coatings are not ideal for use on security documents particularly as a coating for a security paper which is to be printed on as the time taken for typical security inks to dry (oil based lithographic and intaglio inks) will be slower than on paper where the ink can be absorbed into rough paper surface.

Thus the use of MFC is known in the paper and paperboard industry for some limited applications as described above. The present invention has arisen through the surprising discovery that, when used by itself with a paper substrate, and not in conjunction with a polymer layer, it advantageously provides an unexpected level of soil resistance. In addition the use of the MFC material in this manner enable the characteristics of the paper surface to be maintained which provides the improved soil resistance without significantly impacting on the ink drying characteristics of the security paper.

The invention lies in the use of a particular form of cellulose fibre known as microfibrillated cellulose (MFC), which is incorporated into and/or applied to the surface of a paper substrate, to improve the strength of security documents, such as banknotes, made from the substrate and to reduce their uptake of soil due to day to day handling.

The invention therefore provides a soil resistant paper substrate made from a stock comprising a suspension of paper fibres and treated with microfibrillated cellulose such that the microfibrillated cellulose bridges pore spaces formed by and in between the paper fibres at at least a surface of the substrate to provide soil resistance.

The microfibrillated cellulose may be added to the stock, and/or applied to the substrate prior to printing and/or after printing.

The invention further comprises a security paper formed from the aforementioned soil resistant paper comprising an overt security feature to which a transparent microfibrillated cellulose based soil resistant coating or varnish is applied.

The invention additionally comprises a security document comprising the aforementioned soil resistant paper substrate wherein the document is printed before the microfibrillated cellulose is applied as a coating to the surface of the substrate.

The invention also comprises a method of manufacturing a soil resistant paper substrate comprising the steps of forming an intermediate paper substrate from a stock comprising suspension of paper fibres and coating the substrate with a coating comprising microfibrillated cellulose such that the microfibrillated cellulose bridges pore spaces formed by and in between the paper fibres at at least a surface of the substrate to provide soil resistance.

The invention further comprises a method of manufacturing a soil resistant paper substrate comprising the step of adding microfibrillated cellulose to a stock comprising a suspension of paper fibres and forming the substrate such that the microfibrillated cellulose bridges pore spaces formed by and in between the paper fibres at at least a surface of the substrate to provide soil resistance.

The aforementioned problems are thus substantially addressed by the present invention. The microfibrillated cellulose (MFC) has the advantage that it is inherently low cost compared to polymer coatings as it is produced from a common raw material, such as wood or cotton pulp, rather than by a complex chemical synthesis process based on petrochemicals.

Because of its surprising ability to bridge the inherent surface pore structure of paper, significantly less MFC coating is required in order to obtain the same effect as an equivalent polymer coating which provides a processing benefit. This is due to the fibril nature of the MFC which enables it to bridge the pore structure of the paper. Unlike with the known polymer based soil resistant coatings, the MFC coatings of the current invention will not flow into the paper substrate when heated and therefore all of the MFC will be used to bridge the pore structure and therefore improve the soil resistance. With the polymer coating, on the other hand, a significant volume of the coating will flow into the paper structure and only fraction will function as a soil resistant coating on the surface.

Similarly, when MFC is incorporated into the substrate during the paper making process (rather than by means of a coating process which requires additional processing steps), this leads to a reduction in the porosity of the substrate, which improves the resistance of the substrate to soil compared to paper made in the usual way.

Advantageously, with the MFC consisting predominantly of physically-modified cellulose, it undergoes the same biological degradation as the bulk cellulose of the substrate, and spoil can be incorporated directly back into papermaking stock by standard re-pulping processes.

Methods for producing microfibrillated cellulose are described in, for example, GB-A-2066145, in which a liquid suspension of cellulose at high pressure is passed through an orifice to cause an explosive decompression of the suspension and the fibres contained therein. Unfortunately, the energy expenditure required to produce MFC's by mechanical means is very high, requiring approximately 30000 kWh/tonne of product. Alternative approaches are described in, inter alia, WO-A-2007/091942, which discloses an enzymatic process by which microfibrillation of wood pulp can be performed, resulting in a product comparable to that described in GB-A-2066145 but at drastically reduced energy expenditure. The MFC's of the present invention can be prepared from any source of cellulosic material, including wood pulp or preferably cotton fibres. Wood pulp contains 40-50% cellulose, while cotton fibres contain up to around 90% cellulose.

The cellulose found in cotton fibre shows a higher degree of polymerisation in comparison to cellulose derived from other natural fibres and especially soft and hard wood pulps. The combination of higher degree of polymerisation and the higher cellulose content makes it generally harder for the micro fibrillation or homogenisation to easy generate MFC from cotton. Due to the process difficulties cotton would not be a natural choice of base material for generation of MFC.

The following table gives some typical values for the dimensions of cellulose fibres prior to, and following, the above cited microfibrillation process:

| | Length | Width | Thickness |
|---|---|---|---|
| Non- | 0.8-1.2 mm | 10-20 microns | 3-20 microns |
| microfibrillated | | | |
| Cotton | | | |
| Microfibrillated | 1-100 microns | 5-10 nm | 5-10 nm |
| Cellulose | | | |

The length of the fibres in the MFC may be up to 100 microns, and preferably 50 microns or less and is most preferably 10 microns or less.

The width of the fibres in the MFC may be in the range 1 to 100 nm, preferably 2 to 50 nm, preferably 5 to 20 nm and most preferably approximately 5 nm.

The thickness of the fibres may lie in the range 2 to 50 nm, preferably 5 to 20 nm and is most preferably approximately 5 nm.

Note in particular the three or more orders of magnitude by which all of the dimensions of the fibres are reduced during the process.

In one embodiment of the present invention, MFC is used as a coating applied to the external surface of a paper substrate, to provide a substrate from which security documents, such as banknotes can be made, in order to increase soil resistance. Traditionally used polymer-based coatings require a coat weight of approximately 2 grammes/m² (gsm) to provide a soil index of 15-30%. Using MFC, a similar level of soil resistance can be obtained by a significantly lower coat weight in the range of 0.1 to 5 gsm, preferably 0.5 to 3 gsm and is most preferably 1 gsm. In the present context, the soil index is defined as the ratio of the differences in the luminosities of uncoated and coated substrates, subjected to standard soiling procedures, expressed as a percentage. The skilled practitioner will be familiar with the so-called FIRA (Furniture Industry Research Association) Soil test, referred to in WO-A-9628610. In this test, a sample of the paper is placed at one end of a cylinder along with a reference sample placed at the opposite end and 20 felt cubes impregnated with artificial sweat and colloidal graphite. The cylinder is rotated in alternate directions for a period of 30 minutes. The change in reflectance of the printed samples is measured and the relative soil pickup is calculated by comparing the results of the test. In such tests, soil-resistant substrates such as Platinum®-coated paper supplied by De La Rue (United Kingdom) and AST® Paper supplied by Crane & Co (USA) achieve soil indices of between 20-30%. The MFC coated paper substrate of the present invention achieves an equivalent soil index.

It is believed that the microfibrillated cellulose, with its chemically identical structure, has stronger interactions with, and is more efficient at bridging, the pores between the non-microfibrillated fibres of the substrate than the polymeric coatings typically employed. This means that the number of loose fibre ends and the overall surface area of the substrate is reduced, producing a concomitant reduction in soiling. The MFC becomes crystalline as it cures, which helps to seal the pores and to resist oil based soil. Furthermore, the elimination of the differences in hygroscopicity between the coating and the substrate resolves the weaknesses in existing laminar security substrates identified above.

Paper derives its mechanical strength from hydrogen bonding between cellulose microfibrils. The MFC, which is also cellulose, will also have the ability to form hydrogen bonds, not only between the nanofibrils of the MFC but with the cellulose microfibrils of the paper fibres. It will therefore adhere well to the base paper fibres.

MFC can be applied to a paper substrate by any known coating method such as doctor blades, dip roll coating, gravure, flexography etc. with dip coating and gravure being preferred techniques. The MFC is typically delivered to the substrate as a suspension of fibres, preferably in an aqueous medium, the suspension having a solids content of approximately 3% weight for weight (w/w). A particular advantage of using MFC as a coating on a secure paper substrate is that coatings produced from suspensions having a solids content in the range 0.1 to 30% weight for weight (w/w), and preferably in the range 2 to 15% weight for weight (w/w), are transparent and therefore do not affect the appearance of security features incorporated into the paper substrate such as watermarks or embedded or partially embedded security threads. In addition to additional coating methods the MFC can be delivered to the substrate using a size press in line on a paper machine. In this case the MFC is mixed with water to obtain an aqueous formulation having a solids content ranging from about 1-30% dry weight, and more preferably 1-10% dry weight.

In a second embodiment of the present invention, MFC is incorporated throughout the body of the paper substrate by mixing it with standard cotton fibre stock in the papermaking stage of production. In a typical example, the addition of 10% MFC to the bulk of a cotton fibre-based substrate affords a soil index according to the same test as described above of the order of 15%. The stock is preferably formed by adding microfibrillated cellulose to the suspension of paper fibres in a quantity of up to 30% by weight. The MFC is a suspension of fibres in an aqueous medium which preferably has a solids content of 0.01 to 1% w/w, and more preferably 0.05 to 0.5% w/w.

In a third embodiment of the present invention, MFC is used as a post-print varnish to further improve the circulation durability of security documents coated therewith. Printing inks are formulated to optimise their adhesion to the substrate onto which they are to be printed. As the cotton-based substrate and the MFC-based post-print varnish share identical chemistries, the adhesion between varnish, ink and substrate is also optimised. Post-print varnishes may be applied by any suitable coating technique known to the skilled practitioner. Preferred techniques include flexography, which can be used to deposit coat weights of approximately 1 gsm from a 3% w/w suspension of MFC. The formulation of the MFC coating must be selected to be sufficiently transparent not to detract from the underlying print and other security features on the finished security document. A coat weight of approximately 1 gsm from a 3% w/w suspension of MFC would be transparent. The preferred range for the solids content of the suspension of MFC would be from 0.1 to 30% w/w, and more preferably 2 to 15% w/w.

The fibres which are present in the initial paper stock may be all natural fibres or a mixture of natural and synthetic fibres, or all synthetic fibres. The fibres used may be, for example, PVOH, Polyamide, polyester, or other poly olefins.

Although the principal required benefit of using MFC in the present invention is to provide improved soil resistance, it was also found that as the ratio of MFC used in, or added to, the paper was increased, there was a consequential increase in the strength of the paper substrate, a decrease in porosity and an improvement in double folds tests. Double fold tests measure the durability of paper when repeatedly folded under constant load. A Schopper double fold tester may be used to determine the number of times a paper can be folded until it breaks. The folding strength is quoted as the number of double folds until the paper breaks (at 23 C and 50% RH).

These improvements are illustrated by the test results given below.

The following results were obtained in hand tests on 90 gsm hand sheets formed using waterleaf paper stock and MFC. Separate batches of MFC were formed from cotton pulp and wood pulp respectively, and these were added to separate batches of the paper stock in different proportions (0, 5, 10, 15 and 20% w/w as illustrated in the tables below. The MFC was diluted to provide a gel comprising 0.15-0.17% microfibrils in water.

### Wood Pulp MFC

| % | | | Ml | ml |
|---|---|---|---|---|
| MFC | g | g | Vol of MFC | Vol of |
| addition | Dry wt of | MFC dry | to add @ | stock |
| rate | hand sheet | wt/sheet | 0.15% | used |
| 0 | 1.8 | 0 | 0 | 460 |
| 5 | 1.8 | 0.09 | 60 | 435 |
| 10 | 1.8 | 0.18 | 120 | 410 |
| 15 | 1.8 | 0.27 | 180 | 385 |
| 20 | 1.8 | 0.36 | 240 | 360 |

### Cotton Pulp MFC

| % | | | Ml | |
|---|---|---|---|---|
| MFC | g | g | Vol of MFC | ml |
| addition | Dry wt of | MFC dry | to add @ | Vol of |
| rate | hand sheet | wt/sheet | 0.15% | stock used |
| 0 | 1.8 | 0 | 0 | 425 |
| 5 | 1.8 | 0.09 | 60 | 405 |
| 10 | 1.8 | 0.18 | 120 | 385 |
| 15 | 1.8 | 0.27 | 180 | 365 |
| 20 | 1.8 | 0.36 | 240 | 345 |

Eight sheets of each were dried and subjected to tensile strength, double folds and porosity tests with the average results shown below.

The Bendtsen test is a standard test and we can quote ISO 5636-3

| | MFC % | | | | |
|---|---|---|---|---|---|
| | 0 | 5 | 10 | 15 | 20 |
| Bendtsen | 107.7 | 45.7 | 26.7 | 6.7 | 3.3 |
| Porosity | | | | | |
| (ml/min) | | | | | |
| Double Folds | 2091 | 1327 | 2476 | 2335 | 2895 |
| Tensiles | 7.2 | 6.5 | 10.1 | 10.0 | 11.1 |
| (KgF) | | | | | |

### Cotton Pulp MFC

| | MFC % | | | | |
|---|---|---|---|---|---|
| | 0 | 5 | 10 | 15 | 20 |
| Bendtsen | 120 | 77 | 35 | 15 | 6 |
| Porosity | | | | | |
| (ml/min) | | | | | |
| Double Folds | 996 | 2652 | 2158 | 3290 | 3267 |
| Tensiles | 7.2 | 7.9 | 9.1 | 10.1 | 11.5 |
| (KgF) | | | | | |

The increase in the strength of the paper substrate and the improvement in the results from the double-folds test were more significant when cotton based MFC were added to the stock compared to wood based MFC. The additional strength benefits from the cotton based MFC reduces the creation of pores in the paper substrate when in circulation as a banknote or other secure substrate. A reduction in pores leads to a reduction in soiling as the soil tends to accumulate in pores on the surface of a banknote or secure substrate.

In further embodiments MFC can be incorporated both in the stock and applied as a pre-print or post-print coating. In this case the pre-print coating can be applied using a size press.

Additional soil resistant layers can also be coated onto the paper. This could take the form of a conventional pre-print coating which are typically aqueous resin binder systems such as those based on polyurethane dispersions and as described in EP-A-0815321. A typical example is Platinum® as sold by De La Rue International Limited. Alternatively a size press can be used to apply the coating as is known from EP-A-2074260. For example polyether-polyurethane resin based systems are typically used for the size press. The application of a conventional pre-print anti-soil coating over a paper substrate with MFC incorporated into the stock results in a surprisingly significant improvement in soil resistance over that observed without the MFC incorporated into the stock.

In one example paper stock was formed by adding cotton derived MFC to the suspension of paper fibres in a quantity of 15% by weight. The resulting paper was further coated with a size press, as described in EP-A-2074260, using an aqueous formulation from a selection of thermoplastic resins such as resins having an ester bond (e.g. polyester resins and polyether resins), polyurethane resins, functionalized polyurethane resins (e.g. carboxylated polyurethane resins), and copolymers (e.g. urethane-acrylic resins, polyether-urethane resins and styrene acrylate resins) and mixtures thereof. Alternatively the paper was coated with a Platinum® polyurethane using materials and techniques described in EP-A-0815321. The coat weight of such a polyurethane coating will be between 0.05 and 20 gsm and more preferably between 0.5 and 5 gsm.

An improvement in soil resistance was observed when the MFC is incorporated both into the paper substrate and then applied as a coating using a size press. For example, paper stock was formed by adding cotton derived MFC to the suspension of paper fibres in a quantity of 15% by weight and then sized with cotton derived MFC with a consistency of approximately 2% on a dry weight basis using a size press. The size is made by mixing the cotton derived MFC with water so as to form an aqueous formulation having a solids content of 2% by dry weight. Surprisingly a significant further improvement in soil resistance was obtained if the resultant paper was then coated with an additional soil resistant layer, for example with a 2 gsm dry coating of a formulation of polyurethane dispersion, such as Platinum®. The combination of MFC in the paper stock and then application of MFC using a size press followed by a conventional polyurethane soil resistant coating produced a 50% enhancement of the soil resistance compared to that typically achieved by conventional polyurethane products.

This improvement could be explained by the effective closure of micro pores within the paper by MFC. This would reduce the amount of the additional soil resistant layer, such as a conventional polyurethane coating, that would penetrate into the pore in the paper and therefore more of the coating is available on the surface. This results in a more coherent film of polyurethane formation on the surface reducing soil penetration and accumulation.

1-41. (canceled)

42. A soil resistant security paper substrate, comprising:
a stock having a suspension of paper fibres; and
microfibrillated cellulose, the microfibrillated cellulose bridging pore spaces formed by and in between the paper fibres at least at a surface of the stock to provide soil resistance,
wherein the microfibrillated cellulose comprises cotton pulp, fibres in the microfibrillated cellulose have a length in a range of 1 micron to 100 microns, and the fibres in the microfibrillated cellulose have a width in a range of 2 nm to 50 nm.

43. The soil resistant security paper substrate as claimed in claim 42, wherein the microfibrillated cellulose comprises a suspension of fibres in an aqueous medium, and the suspension has a solids content of 0.01% to 1% weight for weight.

44. The soil resistant security paper substrate as claimed in claim 42, wherein the microfibrillated cellulose is added to the stock in a quantity of up to 30% by weight.

45. The soil resistant security paper substrate as claimed in claim 42, wherein the surface of the stock comprises a coating of microfibrillated cellulose.

46. The soil resistant security paper substrate as claimed in claim 45, wherein the coating is a size press coating.

47. The soil resistant security paper substrate as claimed in claim 45, further comprising:
print on the surface of the stock, and wherein the coating is over the print.

48. The soil resistant security paper substrate as claimed in claim 45, wherein the coating has a weight that is in a range of 0.1 gsm to 5 gsm.

49. The soil resistant security paper substrate as claimed in claim 45, wherein the coating is a suspension of fibres in an aqueous medium, and the suspension has a solids content of 0.1% to 30% weight for weight.

50. The soil resistant security paper substrate as claimed in claim 42, wherein the length of the fibres in the microfibrillated cellulose is in the range of 1 micron to 50 microns.

51. The soil resistant security paper substrate as claimed in claim 42, wherein the width of the fibres in the microfibrillated cellulose is in the range of 5 nm to 20 nm.

52. The soil resistant security paper substrate as claimed in claim 42, wherein the fibres in the microfibrillated cellulose have a thickness that is in a range of 1 nm to 100 nm.

53. The soil resistant security paper substrate as claimed in claim 42, further comprising:
an overt security feature forming part of the stock; and
a transparent microfibrillated cellulose based soil resistant coating or varnish applied to the overt security feature.

54. The soil resistant security paper substrate as claimed in claim 42, further comprising:
a printed document on the stock; and
a microfibrillated cellulose coating over the printed document.

55. A method of manufacturing a soil resistant security paper substrate comprising:
adding microfibrillated cellulose to a stock comprising a suspension of paper fibres; and
forming the substrate,
wherein the microfibrillated cellulose bridges pore spaces formed by and in between the paper fibres at least at a surface of the stock to provide soil resistance, and
wherein the microfibrillated cellulose comprises cotton pulp, fibres in the microfibrillated cellulose have a length in a range of 1 micron to 100 microns, and the fibres in the microfibrillated cellulose have a width in a range of 2 nm to 50 nm.

56. The method of manufacturing the soil resistant security paper substrate as claimed in claim 55, wherein the microfibrillated cellulose is added to the stock in a quantity of up to 30% by weight.

57. The method of manufacturing the soil resistant security paper substrate as claimed in claim 55, wherein the microfibrillated cellulose is added to the stock as a suspension of fibres in an aqueous medium, and the suspension has a solids content of 0.01% to 1% weight for weight.

58. The method of manufacturing the soil resistant security paper substrate as claimed in claim 55, further comprising:
applying a coating of microfibrillated cellulose to the surface of the stock.

59. The method of manufacturing the soil resistant security paper substrate as claimed in claim 58, wherein the step of applying a coating comprises size pressing.

60. The method of manufacturing the soil resistant security paper substrate as claimed in claim 55, further comprising:
printing on the stock, and
coating the surface of the stock with microfibrillated cellulose after the step of printing.

61. The method of manufacturing the soil resistant security paper substrate as claimed in claim 58, wherein the coating has a weight, and the weight is in a of range 0.1 gsm to 5 gsm.

62. The method of manufacturing the soil resistant security paper substrate as claimed in claim 58, wherein the coating is a suspension of fibres in an aqueous medium, and the suspension has a solids content of 0.1% to 30% weight for weight.

63. The method of manufacturing the soil resistant security paper substrate as claimed in claim 55, wherein the length of the fibres in the microfibrillated cellulose is in the range of 1 micron to 50 microns.

64. The method of manufacturing the soil resistant security paper substrate as claimed in claim 55, wherein the width of the fibres in the microfibrillated cellulose is in the range of 5 nm to 20 nm.

65. The method of manufacturing the soil resistant security paper substrate as claimed in claim 55, wherein the fibres in the microfibrillated cellulose have a thickness in a range of 1 nm to 100 nm.

66. The method of manufacturing the soil resistant security paper substrate as claimed in claim 55 further comprising:
applying a soil resistant layer.

67. The method of manufacturing the soil resistant security paper substrate as claimed in claim 66, further comprising:
printing on the stock before applying the soil resistant layer.

68. The method of manufacturing the soil resistant security paper substrate as claimed in claim 66, further comprising:
printing on the stock after applying the soil resistant layer.
